(19) United States
(12) Patent Application Publication
(10) Pub. No.: US 2008/0274238 A1
(43) Pub. Date: Nov. 6, 2008

(54) SINGLE SERVING PACKAGED POTATO

(76) Inventors: Gary J. Wysocki, Bancroft, WI (US); Russell M. Wysocki, Custer, WI (US)

Correspondence Address: MICHAEL BEST & FRIEDRICH LLP, ONE SOUTH PINCKNEY STREET, P O BOX 1806, MADISON, WI, 53701, US

(21) Appl. No.: 12/136,349

(22) Filed: Jun. 10, 2008

Related U.S. Application Data
(63) Continuation of application No. 11/426,803, filed on Jun. 27, 2006, now abandoned.
Application No. 11/426,803 is a continuation of application No. 11/153,092, filed on Jun. 15, 2005, now abandoned.
(60) Provisional application No. 60/580,653, filed on Jun. 17, 2004.

(51) Int. Cl. A23L 1/216; B65D 81/34

(52) U.S. Cl. 426/113; 426/124; 426/112; 426/115

(57) ABSTRACT

A prepackaged potato is contained within a serving receptacle that also includes items for use in consumption of the potato, which may be in the form of utensils, toppings and the like. The serving receptacle defines an interior within which the potato and the items for use in consumption of the potato are contained, and which is covered by a wrap material, a lid or a cover. The lid or cover may be formed with a cutout or window, which allows a consumer to view at least a portion of the contents of the serving receptacle. The lid or cover includes a label that bears nutrition information as well as instructions for preparation of the potato.

### CROSS REFERENCE TO RELATED APPLICATIONS

This application is a continuation of U.S. application Ser. No. 11/426,803, filed Jun. 27, 2006, which is a continuation of U.S. application Ser. No. 11/153,092, filed Jun. 15, 2005, which claims priority to U.S. Provisional Application No. 60/580,653, filed Jun. 17, 2004, all of which are incorporated herein by reference in their entirety.

### BACKGROUND AND SUMMARY OF THE INVENTION

The present invention relates to the packaging of potatoes, and more particularly relates to packaging of single potatoes for individual consumption.

Potatoes are an excellent source of vitamin C and potassium, and provide a natural source of vitamin B₆ and dietary fiber. In addition, potatoes are fat-free, cholesterol-free, and relatively low in calories. Potatoes are an excellent diet food, since they are remarkably nutritious and filling. However, the perception of potatoes among consumers has suffered as a result of the many unhealthy ways in which potatoes are often prepared, e.g. potato chips, french fries, etc.

One of the healthiest ways to prepare a potato is to bake it whole. Yet many consumers, harkening back to the days before microwave ovens, consider the process of baking a potato to be a time-consuming chore. Prior art packaging of potatoes does nothing to combat this misperception. Potatoes are typically packaged in bulk quantities, such as in 5 lb. or 10 lb. bags. Potatoes are also sold individually, with the price dependent upon the weight of the potato. In both cases, the potato must be washed, and in neither case does the potato come with instructions for easy, healthful preparation. Furthermore, after preparation of a baked potato, the consumer will be required to gather a variety of accessories for eating the potato, including a knife, fork, or spoon and any flavorings, toppings or condiments he or she wishes to add to the potato for enhancing the flavor.

As a result, neither of the prior methods of selling potatoes helps the consumer to understand the health benefits of baked potatoes or provides an easy way to transport an individual potato and prepare it away from home. In addition, neither method provides convenience with respect to enjoying favorite toppings with the individually prepared baked potato, especially when the potato is prepared away from home. In addition, neither method lends itself to convenience in the retail sale of a single serving potato to make it easy for a consumer to purchase a potato along with accessories, flavoring, toppings and/or condiments that are necessary or desirable for consumption of the potato.

Therefore, what is needed is a way to package individual potatoes to attract health-conscious consumers and make an individual potato easy to sell, transport and prepare. A way to provide convenient access to baked potato toppings is also desirable.

The present invention is directed to a prepackaged potato that is contained within a serving receptacle that also includes items for use in consumption of the potato, which may be in the form of utensils, toppings and the like. The potato and the items for use in consumption of the potato are preferably contained within an interior defined by the serving receptacle, which is preferably covered with a wrap material, a lid or a cover. The potato may be wrapped with a wrap material, which may be in the form of a transparent plastic wrap. The lid or cover of the receptacle may be formed with a cutout or window, which allows a consumer to view at least a portion of the contents of the serving receptacle. In a preferred form, the lid or cover includes a label that bears nutrition information as well as instructions for preparation of the potato. This feature is especially desirable when the prepackaged potato is displayed in a retail environment. With this construction, the consumer is able to open the package by removing the lid or cover, and to remove the contents of the receptacle other than the potato. The consumer can then microwave the potato, either by removing the potato from the receptacle or leaving the potato in the serving receptacle. The consumer then removes the wrap material from the potato after the potato is cooked. The potato can then be placed back into the receptacle for preparation, or can be prepared in a regular dish supplied by the consumer. The potato is prepared for consumption using the toppings, condiments and flavorings supplied in the package, either using the utensils supplied with the package or using utensils supplied by the consumer.

The invention also contemplates a method of packaging a potato in which the potato is first washed, and then placed in an individual serving container or receptacle. The potato may be covered with a wrap material. Various s toppings, condiments or flavorings are placed into the container or receptacle along with the potato. The container or receptacle may be covered with a cap or lid, or may be both covered with a film.

With the present invention, a consumer may purchase a single serving baked potato, together with desired toppings and necessary utensils. The consumer is able to conveniently transport the single serving package, e.g. to work, school, etc., and is provided with instructions for microwave cooking the potato as well as a container or receptacle for cooking and eating the potato, along with utensils.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a top plan view of a single serving packaged potato in accordance with the present invention; and

FIG. 2 is a top plan view showing the components incorporated in the single serving packaged potato of FIG. 1.

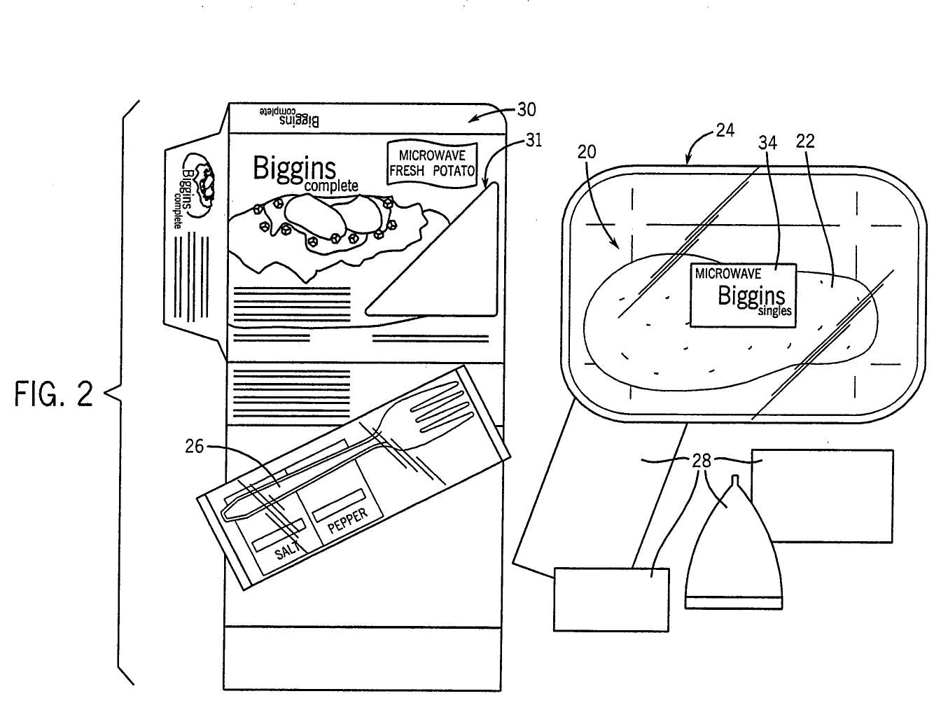

### DETAILED DESCRIPTION OF THE INVENTION

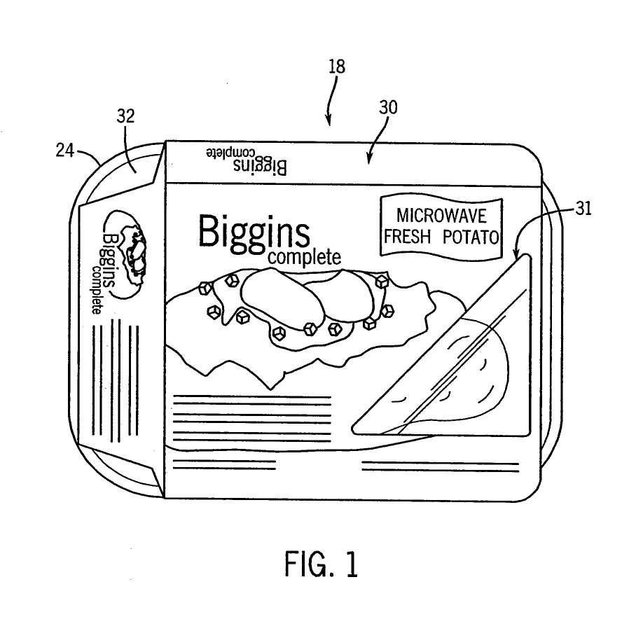

A preferred embodiment of the present invention is shown in FIG. 1. A single serving packaged potato 18 includes a washed potato 20 wrapped in a film 22 and placed in an individual serving container 24. Film 22 may be air permeable or air impermeable, and may be wrapped around potato 20 in any number of suitable ways, including shrink wrapping, vacuum wrapping, or stretch wrapping. Alternatively, potato 20 may be left unwrapped for placement in container 24. Container 24 may be made of any suitable materials, including plastic, paperboard, or foam, and may be generally rectilinear, as shown in FIG. 1, or may be circular or oblong to better simulate a bowl or serving boat. Preferably, container 24 is disposable and microwave safe.

In addition to potato 20, container 24 may hold utensils 26 and toppings 28. Utensils 26 may include a fork, knife, spoon, or a combination fork-and-spoon, sometimes known as a “spork.” A common foodservice assemblage including a napkin, fork, salt sachet, and pepper sachet, all packaged together in clear plastic wrap, is used in the illustrated embodiment. In this manner, the utensils 26 are maintained separate from the potato 20, as are any other items packaged along with utensils 26.

Toppings 28 may include any number of individually packaged containers of salt, pepper, herbs, spices, dried produce, dried meat, flavored powders, dressings, sauces, spreads, or condiments. As noted, in the illustrated embodiment, salt and pepper packages are included with utensils 26. In addition, toppings 28 may include: bacon bits; salsa; dried chives, onion, and/or parsley; garlic or seasoned salt or powder; ranch, thousand island, French, Italian, or other flavored dressings; sour cream; butter; and cheese, cheese powder, or cheese sauce. It should be noted that toppings 28 are not limited to the items recited above, and may include any other flavor enhancing items or combination of items. Furthermore, of the toppings listed, any number of suitable replacements may be made without departing from the scope of the invention. For example, the bacon bits may be imitation bacon bits, the dressings may be fat-free or reduced calorie, and the butter may be a butter substitute. Substitutes will be particularly important when the desired topping 28 does not have a shelf life matching the shelf life of potato 20. Toppings 28 may include dairy items such as cheese, sour cream, and butter, which may require refrigeration. Alternative non-perishable substitutes for such toppings may be provided.

Container 24 may be enclosed using a lid or cover 30. Alternatively, container 24 may be covered using another layer of film, or a combination of both a lid or cover and a layer of film. As with film 22 for wrapping potato 20, the additional layer of film may be air permeable or air impermeable, and may be wrapped around container 24 in any number of suitable ways, including shrink wrapping, vacuum wrapping, or stretch wrapping. Lid or cover 30 may be constructed of a paperboard material, which includes a top panel that overlies the upwardly facing interior of container 24, and a series of depending side panels that extend downwardly from the edges of the top panel for securement to the side walls of container 24. Alternatively, and in a preferred embodiment, cover 30 may be in the form of a sleeve that defines a passage into which container 24 is inserted. The cover 30 may be formed of paperboard or a semi-rigid plastic or other satisfactory material, and is constructed so as to be easily removed from container 24. In this manner, the user can easily remove the lid or cover 30 to access the interior of container 24 and the items contained within the container interior.

Lid or cover 30 preferably includes a cutout or window 31, which enables a potential consumer to view the contents of the container 24. In this manner, the consumer can visually verify the size and appearance of the potato, and can ascertain that various items such as utensils, toppings, flavorings and condiments are packaged within the container 24 along with the potato. Again, if desired, an overwrap layer of plastic film may be placed about the lid or cover 30, to seal the interior of container 24.

Lid or cover 30 bears a various information pertaining the potato 20, including trademarks, nutrition information, cooking instructions and other preparation information, etc. The information may be printed directly onto the outer surfaces of lid or cover 30, or may be in the form of stickers or the like. In addition, a label 34 may be applied to the wrap material within which potato 20 is contained. It can be appreciated that any number of known methods of marking may be used.

In use, the consumer purchases the single serving packaged potato 18, which includes utensils 26 and toppings 28 at his or her local market and transports it to his or her home, work, or another location where he or she has access to a microwave oven. When desired, the consumer opens single serving packaged potato 18 by removing lid or cover 30, outer film 32, or both if both are present. The consumer removes utensils 26 and toppings 28 from container 24 and places potato 20 in the microwave oven. If potato 20 is wrapped with film 22, the film 22 is left intact around potato 20 while being cooked. If potato 20 is unwrapped, it may be cooked alone or inside container 24. If cooked inside container 24, and a wrap material is provided, potato 20 may be covered with the wrap material.

After cooking, potato 20 is replaced within container 24 and opened with one of utensils 26. Alternatively, the consumer may place potato 20 in a conventional glass or ceramic dish, and may use conventional metal utensils. Film 22 may be discarded. The consumer adds toppings 28 and eats baked potato 20 with utensils 26.

It can thus be appreciated that the present invention enables a consumer to purchase a single serving baked potato, complete with desired toppings and necessary utensils. The consumer is able to conveniently transport the single serving package, e.g. to work, school, etc., and is provided with instructions for microwave cooking the potato as well as a container or receptacle for cooking and eating the potato, along with utensils.

Various alternatives and embodiments are contemplated as being within the scope of the following claims particularly pointing out and distinctly claiming the subject matter regarded as the invention.

We claim:

1. A packaged potato arrangement, comprising: a container defining an interior; a potato wrapped with a wrap material, the wrapped potato being placed within the interior of the container;
one or more items for use in consumption of the potato within the interior of the container along with the potato; and
a cover arrangement overlying the interior of the container and configured to maintain the potato and the one or more items within the interior of the container.

2. The packaged potato arrangement of claim 1, wherein the one or more items for use in consumption of the potato include a package containing one or more utensils, in combination with one or more edible items for consumption along with the potato.

3. The packaged potato arrangement of claim 2, wherein the one or more edible items are selected from the group consisting of herbs, spices, dried produce, dried meat, flavored powders, dressings, sauces, spreads, and condiments.

4. The packaged potato arrangement of claim 1, wherein the cover arrangement is opaque and includes an opening through which the potato and the one or more items for use in consumption of the potato are visible.

5. The packaged potato arrangement of claim 4, wherein the cover arrangement comprises a sleeve configured to receive the container.

6. A method of preparing a potato in a packaged potato arrangement of claim 2, comprising the steps of removing the cover arrangement from the container, cooking the potato, and using the utensils and the one or more edible items to prepare the potato for consumption

7. A method of packaging a potato comprising the steps of:
wrapping a potato with wrap material;
placing the wrapped potato in an individual serving container;
placing one or more items for use in consumption of potato into the individual serving container along with the potato; and
covering the individual serving container.

8. The method of claim 7, wherein the step of placing one or more items for use in consumption of the potato into the container is carried out by placing a package containing one or more utensils into the container, in combination with one or more edible items for consumption along with the potato.

9. The method of claim 8, wherein the step of placing one or more edible items for consumption along with the potato into the container comprises placing one or more of herbs, spices, dried produce, dried meat, flavored powders, dressings, sauces, spreads, and condiments into the container.

10. The method of claim 7, wherein the serving container defines an interior having an open top, and wherein the step of covering the individual serving container is carried out by placing a cover over the open top of the serving container.

11. The method of claim 10, wherein the cover is generally opaque and includes an opening to provide visual access to the potato and the one or more items for use in consumption of the potato.

12. The method of claim 11, wherein the cover comprises a sleeve having an open end, and including the step of inserting the container and the potato into the open end of the sleeve.

13. A method of preparing a potato comprising the steps of:
providing a container defining an interior in which a wrapped potato was located, the container including one or more items for use in consumption of the potato in a cover at least partially enclosing the interior of the container to hold the wrapped potato and the one or more items therein;
removing the cover from the container;
removing the one or more items from the container;
heating the wrapped potato; and
removing the wrapping material from the potato to provide an unwrapped potato.

14. The method of claim 13 wherein the step of heating the wrapped potato comprises
heating the wrapped potato within the container.

15. The method of claim 13 further comprising the step of removing the wrapped potato from the container prior to heating the wrapped potato.

16. The method of claim 15 further comprising the step of replacing the unwrapped potato within the container after heating the potato.

17. The method of claim 13 further comprising the step of using the one or more items for use in consumption of the potato to consume potato after heating the potato
